(19) United States
(12) Patent Application Publication
(10) Pub. No.: US 2021/0090322 A1
(43) Pub. Date: Mar. 25, 2021

(54) Generating and Modifying Representations of Objects in an Augmented-Reality or Virtual-Reality Scene

(71) Applicant: Facebook Technologies, LLC, Menlo Park, CA (US)

(72) Inventor: Warren Andrew Hunt, Woodinville, WA (US)

(21) Appl. No.: 16/583,107

(22) Filed: Sep. 25, 2019

(51) Int. Cl. G06T 15/20; G06T 15/06; G06T 17/20; G06F 3/01

(52) U.S. Cl. CPC G06T 15/20; G06T 15/06; G06F 3/012; G06F 3/013; G06T 17/20

(57) ABSTRACT

In one embodiment, a method includes accessing a surface representing represents one or more virtual objects. The surface is associated with a heightmap and a texture, each of which is generated based on rendered information that was generated at a first frame rate. A set of subframes are then rendered at a second frame rate higher than the first frame rate. Each subframe is generated by determining a current viewpoint of a user, determining visibility information of the surface by casting rays against the heightmap from the current viewpoint, and generating the subframe depicting the surface from the current viewpoint based on the visibility information of the surface and the texture. The set of subframes are then displayed to the user.

### TECHNICAL FIELD

This disclosure generally relates to augmented-reality, virtual-reality, mixed-reality, or hybrid-reality environments.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Since its existence, artificial reality (e.g., AR, VR, MR) technology has been plagued with the problem of latency in rendering AR/VR/MR objects in response to sudden changes in a user's perspective of an AR/VR/MR scene. To create an immersive environment, users may need to be able to move their heads around when viewing a scene and the environment may need to respond immediately by adjusting the view presented to the user. Each head movement may slightly change the user's perspective of the scene. These head movements may be small but sporadic and difficult (if not impossible) to predict. A problem to be solved is that the head movements may occur quickly, requiring that the view of the scene be modified rapidly to account for changes in perspective that occur with the head movements. If this is not done rapidly enough, the resulting latency may cause a user to experience a sensory dissonance that can lead to virtual reality sickness or discomfort, or at the very least, a disruption to the immersive nature of the experience. Re-rendering a view in its entirety to account for these changes in perspective may be resource intensive, and it may only be possible to do so at a relatively low frame rate (e.g., 60 Hz, or once every 1/60th of a second). As a result, it may not be feasible to modify the scene by re-rendering the entire scene to account for changes in perspective at a pace that is rapid enough (e.g., 200 Hz, once every 1/200th of a second) to prevent the user from perceiving latency and to thereby avoid or sufficiently reduce sensory dissonance.

One solution involves generating and working with “surfaces” that represent objects within the scene. In particular embodiments, graphics applications (e.g., games, maps, content-providing apps, etc.) may build a scene graph, which is used together with a given view position and point in time to generate primitives to render on a GPU. The scene graph may define the logical and/or spatial relationship between objects in the scene. In particular embodiments, a warp engine may also generate and store a scene graph that is a simplified form of the full application scene graph. The simplified scene graph may be used to specify the logical and/or spatial relationships between surfaces (e.g., the primitives rendered by a warp engine defined in 3D space, that have corresponding textures generated based on the mainframe rendered by the application). Storing a scene graph allows the warp engine to render the scene to multiple display frames, adjusting each element in the scene graph for the current viewpoint (e.g., head position), the current object positions (e.g., they could be moving relative to each other) and other factors that change per display frame. In addition, based on the scene graph, the warp engine may also adjust for the geometric and color distortion introduced by the display subsystem and then composite the objects together to generate a frame. Storing a scene graph allows the warp engine to approximate the result of doing a full render at the desired high frame rate, while actually running the GPU at a significantly lower rate.

A surface may correspond to one or more objects that are expected to move/translate, skew, scale, distort, or otherwise change in appearance together, as one unit, as a result of a change in perspective. Instead of re-rendering the entire view, a computing system may simply resample these surfaces from the changed perspective to approximate how a corresponding object would look from the changed perspective. This method may essentially be an efficient shortcut, and may significantly reduce the processing that is required, thus ensuring that the view is updated quickly enough to sufficiently reduce latency. Resampling surfaces, unlike re-rendering entire views, may be efficient enough that it can be used to modify views within the allotted time—e.g., in 1/200th of a second—with the relatively limited processing power of a computing system of an HMD. The time scales involved in this modification are so small that it may be unfeasible to have a more powerful system that is physically separated from the HMD (e.g., a separate laptop or wearable device) perform the modification, because the HMD would have to transmit information about the current position and orientation of the HMD, wait for the separate system to render the new view, and then receive the new view from the separate system. By simply resampling surfaces, the modification may be performed entirely on the HMD, thus speeding up the process. Although this disclosure uses particular time periods ( 1/60th of a second, 1/200th of a second) and corresponding particular frame rates (60 Hz, 200 Hz), these time periods and frame rates are used merely as examples to illustrate the invention, and the disclosure contemplates any other suitable time periods and frame rates.

Embodiments of the invention may include or be implemented in conjunction with an artificial reality system. In particular embodiments, the processing tasks involved in rendering a scene and generating and modifying its surfaces may be split among two or more computing systems. As an example and not by way of limitation, a view of a scene may initially be rendered by a first computing system (e.g., a laptop, a cellphone, a desktop, or a wearable device) at a relatively low frame rate (e.g., 60 hz). The rendered results may be used to generate, by the first computing system or a second computing system, one or more surfaces (e.g., 16 surfaces) for an AR/VR scene. In addition to color and transparency information, the surfaces may include information about their position and orientation in the scene. This position and orientation information is used by a ray caster to determine how the surfaces should be displayed to the user based on a current position and angle of view of the user. These surfaces may then be processed by a warp engine on a second computing system (e.g., an onboard computing system on a head-mounted display (HMD)). The HMD may render the objects corresponding to the surfaces within the view based on the information associated with the surfaces and based on a current perspective of the user wearing the HMD (e.g., as determined by the position and orientation of the HMD). Any changes in perspective (e.g., slight head motions of the user that occur on the order of a hundredth of a second) may be tracked by sensors on the HMD and accounted for by the HMD by resampling the surfaces in a view from an adjusted viewpoint. Due to the adjustment of the viewpoint, the surfaces may be translated/moved, skewed, scaled, distorted, or otherwise changed in appearance when they are resampled. Since the scene is not being re-rendered from scratch (e.g., from polygons) and instead just by adjusting surfaces, the scene can be modified relatively quickly (e.g., at 200 Hz). In particular embodiments, the first computing system may be relatively powerful when compared to the second computing system, because the second computing system (e.g., an HMD) may have limited system resources that may not appreciably be increased without resulting in too much weight, size, and/or heat for user comfort.

In certain embodiments, a surface may be represented by a flat quadrilateral in space or it may be represented by a heightmap to provide information about the contour(s) of the object(s) represented by the surface. Having a surface represented by a flat “poster-like” quadrilateral optimizes for performance and computational efficiency. However, such a surface representation loses information about the three-dimensional aspects of the objects being represented, which could be needed for properly resolving occlusions, for example. Thus, certain applications may prefer to use surfaces with three-dimensional information about the contours of the visible portion of objects depicted in the surfaces. Such heightmaps may be generated from the viewpoint of a virtual camera as a surface with topology/height information. Conceptually, a contour of a surface may be represented by a continuous mesh, with each vertex in the mesh having an assigned height information (e.g., the height information may be measured relative to the plane in which the flat quadrilateral surface would reside). The heightmap may be generated in a number of ways. When the surface depicts a virtual representation of a physical object within the view of the user, the contour or height information of the virtual object may be defined by depth information obtained using depth sensors or stereo computations of the physical object. Alternatively, when a virtual object is rendered, the contour may be defined based on known 3D data of the virtual object (e.g., as part of the graphics-rendering pipeline, depth data in the depth buffer or z-buffer may be used to generate the heightmap for the surface).

During rendering, visibility of a surface may now be solved using a heightmap, as a ray cast into the scene from the viewpoint intersects the heightmap of the surface. Such use of a heightmap offers several advantages. For instance, a surface with height information allows for more accurate perspective adjustments and realistic subframe rendering. Additionally, a heightmap is a simple and natural data structure to use, as a depth map is already a byproduct of 3D rendering and can be used to generate the heightmap. Still further, the amount of data movement required to implement a heightmap is low since the associated computations can occur locally on the AR/VR system. This may allow a scene to be rendered at a higher frame rate, as is important for such displays that must respond rapidly to user movement.

Another benefit of using a heightmap is to allow proper re-projection of information captured by external-facing cameras to the user. For example, in certain applications, a VR/AR system may have external-facing cameras that could be used to observe and measure the depth of physical objects in the user's surrounding. The information captured by the cameras, however, would be misaligned with what the user's eyes would capture, since the cameras could not spatially coincide with the user's eyes (e.g., the cameras would be located some distance away from the user's eyes and, consequently, have different viewpoints). As such, simply displaying what the cameras captured to the user would not be an accurate representation of what the user should perceive. The heightmap described herein could be used to properly re-project information captured by external-facing cameras to the user. The VR/AR headset, for example, may have two external-facing cameras that have an overlapping field of view. When the cameras observe a common feature in the physical environment, the VR/AR system could use triangulation techniques to compute a depth of the feature. Based on the computed depth of the feature relative to the cameras, the VR/AR system could determine where that feature is located within a 3D space (since the VR/AR system also knows where the cameras are in that 3D space). Such measured depth information may be used to generate a heightmap for a surface that represents the object having the observed feature. When the system renders a scene for display, the system could perform visibility tests from the perspective of the user's eyes. For example, the system may cast rays into the 3D space from a viewpoint that corresponds to each eye of the user through the pixels of a representation of a display screen. If a ray intersects a surface with a heightmap, then the color for the corresponding pixel through which the ray was cast may be determined based on the point of intersection and the texture associated with that surface. In this manner, the rendered scene that is displayed to the user would be computed from the perspective of the user's eyes, rather than from the perspective of the external-facing cameras.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims, but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1F illustrate examples of scenes that include objects that may be represented by surfaces.

FIGS. 2A-2D illustrate conceptual illustrations of a surface with an associated heightmap, and of the storage of that heightmap.

FIG. 3 illustrates a first “ray-casting” process for determining visual information and location information of an object that is to be displayed within a view of a scene.

FIG. 4 illustrates a process of converting a 2D representation of the object to a surface.

FIG. 5 illustrates an example process of a second ray-casting process for rendering the object for display from a viewpoint of a scene based on information associated with a corresponding surface.

FIGS. 6-8 illustrate the processes of FIGS. 3-5, respectively, for a surface associated with a heightmap.

FIG. 9 illustrates an example of rendering a surface based on its associated heightmap.

FIG. 10 illustrates a process of identifying visual information that corresponds to points of intersection with a flat surface represented by a quadrilateral.

FIG. 11 illustrates an example method for generating subframes based on surfaces.

FIG. 12 illustrates an example high-level architecture for a display engine.

FIG. 13 illustrates an example HMD system wirelessly connected to a computer system.

FIG. 14 illustrates an example computer system.

### DESCRIPTION OF EXAMPLE EMBODIMENTS

Since its creation, artificial reality (e.g., AR, VR, MR) technology has been plagued with the problem of latency in rendering AR/VR/MR objects in response to sudden changes in a user's perspective of an AR/VR/MR scene. To create an immersive environment, users may need to be able to move their heads around when viewing a scene and the environment may need to respond immediately by adjusting the view presented to the user. Each head movement may slightly change the user's perspective of the scene. These head movements may be small but sporadic and difficult (if not impossible) to predict. A problem to be solved is that the head movements may occur quickly, requiring that the view of the scene be modified rapidly to account for changes in perspective that occur with the head movements. If this is not done rapidly enough, the resulting latency may cause a user to experience a sensory dissonance that can lead to virtual reality sickness or discomfort, or at the very least, a disruption to the immersive nature of the experience. Re-rendering a view in its entirety to account for these changes in perspective may be resource intensive, and it may only be possible to do so at a relatively low frame rate (e.g., 60 Hz, or once every 1/60th of a second). As a result, it may not be feasible to modify the scene by re-rendering the entire scene to account for changes in perspective at a pace that is rapid enough (e.g., 200 Hz, once every 1/200th of a second) to prevent the user from perceiving latency and to thereby avoid or sufficiently reduce sensory dissonance. One solution involves generating and working with “surfaces” that represent a particular view of an objects within the scene, where a surface corresponds to one or more objects that are expected to move/translate, skew, scale, distort, or otherwise change in appearance together, as one unit, as a result of a change in perspective. Instead of re-rendering the entire view, a computing system may simply resample these surfaces from the changed perspective to approximate how a corresponding object would look from the changed perspective. This method may essentially be an efficient shortcut, and may significantly reduce the processing that is required and thus ensure that the view is updated quickly enough to sufficiently reduce latency. Resampling surfaces, unlike re-rendering entire views, may be efficient enough that it can be used to modify views within the allotted time—e.g., in 1/200th of a second—with the relatively limited processing power of a computing system of an HMD. The time scales involved in this modification are so small that it may be unfeasible to have a more powerful system that is physically separated from the HMD (e.g., a separate laptop or wearable device) perform the modification, because the HMD would have to transmit information about the current position and orientation of the HMD, wait for the separate system to render the new view, and then receive the new view from the separate system. By simply resampling surfaces, the modification may be performed entirely on the HMD, thus speeding up the process.

Embodiments of the invention may include or be implemented in conjunction with an artificial reality system. In particular embodiments, the processing tasks involved in rendering a scene and generating and modifying its surfaces may be split among two or more computing systems. As an example and not by way of limitation, a view of a scene may initially be rendered by a first computing system (e.g., a laptop, a cellphone, a desktop, a wearable device) at a relatively low frame rate (e.g., 60 hz). The rendered results may be used to generate one or more surfaces (e.g., 16 surfaces) for an AR/VR view. In addition to color and transparency information, the surfaces may include information about their position and orientation in the scene. This position and orientation information is used by a ray caster to determine how the surface should be displayed to the user based on a current position and angle of the view of the user. These surfaces may then be passed to a second computing system (e.g., an onboard computing system on a head-mounted display (HMD)). The HMD may warp the surfaces within the view based on the information associated with the surfaces and based on a current perspective of the user wearing the HMD (e.g., as determined by the position and orientation of the HMD). Any changes in perspective (e.g., slight head motions of the user that occur on the order of a hundredth of a second) may be tracked by sensors on the HMD and accounted for by the HMD by resampling the surfaces in a view from an adjusted viewpoint. Due to the adjustment of the viewpoint, the surfaces may be translated/moved, skewed, scaled, distorted, or otherwise changed in appearance when they are resampled. Since the scene is not being re-rendered from scratch (e.g., from polygons) and instead just by adjusting surfaces, the scene can be modified relatively quickly (e.g., at 200 Hz). In particular embodiments, the first computing system may be relatively powerful when compared to the second computing system, because the second computing system (e.g., an HMD) may have limited system resources that may not appreciably be increased without resulting in too much weight, size, and/or heat for the user's comfort.

In particular embodiments, a computing system may render an initial view of a scene for display to a user. As an example and not by way of limitation, this initial view may be a view of an AR scene including a set of AR objects (or, as discussed elsewhere herein, a VR scene with VR objects). In particular embodiments, the display may be on an HMD. An HMD may have limited system resources and a limited power supply, and these limitations may not be appreciably reduced without resulting in too much weight, size, and/or heat for user comfort. As a result, it may not be feasible for the HMD to unilaterally handle all the processing tasks involved in rendering a view. In particular embodiments, a relatively powerful computing system (e.g., a laptop, a cellphone, a desktop, or a wearable device) may be used to render the initial view. In particular embodiments, this computing system may be a device that is in communication with a computing system on the HMD but may be otherwise physically separated from the HMD. As an example and not by way of limitation, the computing system may be a laptop device that is wired to the HMD or communicates wirelessly with the HMD. As another example and not by way of limitation, the computing system may be a wearable device (e.g., a device strapped to a wrist), handheld device (e.g., a phone), or some other suitable device (e.g., a laptop, a tablet, or a desktop) that is wired to the HMD or communicates wirelessly with the HMD. The computing system may send this initial scene to the HMD for display. Although this disclosure focuses on displaying a scene to a user on an HMD, it contemplates displaying the scene to a user on any other suitable device.

Rendering a view is a resource-intensive task that may involve performing a large number of “visibility tests” against each polygon of an object. In a traditional model of rendering a view of a scene, each object in the scene may be represented by hundreds/thousands of polygons. A computing system rendering the view would need to perform visibility tests against each polygon from each pixel to determine visual information (e.g., color and transparency information) associated with each visible polygon. Visibility testing may be conceptualized as casting one or more imaginary rays through each pixel at the scene from a particular viewpoint, and determining if the rays intersect a polygon of an object. If there is an intersection, the pixel may be made to display a shading (e.g., color, transparency) based on visual information associated with the polygon that is intersected by the ray. This is repeated for each pixel in what may be described as a “ray-casting” or a “ray-tracing” process, and it may ultimately result in a rendering of an entire view on a screen. This kind of rendering takes time. As an example and not by way of limitation, even with a laptop/desktop, frames may only be rendered in this way at 60 Hz, which means that any changes in perspective that occur within 1/60th of a second (e.g., from a rapid head movement) would not be captured by what is rendered/displayed.

To address this problem, in particular embodiments, a computing system may generate one or more “surfaces” for a scene to efficiently deal with rendering views quickly, as will be explained further below. Each surface may be a representation of one or more objects within the scene that are expected to move/translate, skew, scale, distort, or otherwise change in appearance together, as one unit, as a result of a change in a user's perspective of the scene (e.g., resulting from an HMD on a user's head moving to a different position and/or orientation). As an example and not by way of limitation, an avatar of a person and a hat worn by the avatar may correspond to one surface if it is determined that the person and the hat would move/translate, skew, scale, distort, or otherwise change in appearance together, as one unit. In particular embodiments, a surface may correspond to sets of points (e.g., points making up an object) that are expected to move/translate, skew, scale, distort, or otherwise change in appearance as a single unit when a user's perspective of a scene changes. In particular embodiments, a surface may be a rectangular “texture,” which may be a virtual concept that includes visual information (e.g., colors, transparency) defining one or more objects in a scene. The surface may also include an associated heightmap. The surface may also include a transformation matrix to specify its location in the scene. A surface's texture data may be made up of one or more subparts, referred to herein as “texels.” These texels may be blocks (e.g., rectangular blocks) that come together to create a texel array that makes up a surface. As an example and not by way of limitation, they may be contiguous blocks that make up a surface. For illustrative purposes, a texel of a surface may be conceptualized as being analogous to a pixel of an image. A surface may be generated by any suitable device. As an example and not by way of limitation, a CPU or GPU of a wearable or handheld device that generated the initial scene may also generate one or more surfaces for the scene. As another example and not by way of limitation, an onboard computing system of an HMD may generate one or more surfaces after it receives the initial scene from a separate computing system (e.g., from a CPU or GPU of a wearable, handheld, or laptop device). In particular embodiments, there may be a predefined maximum number of surfaces that may be generated for a view (e.g., 16 surfaces) for efficiency purposes.

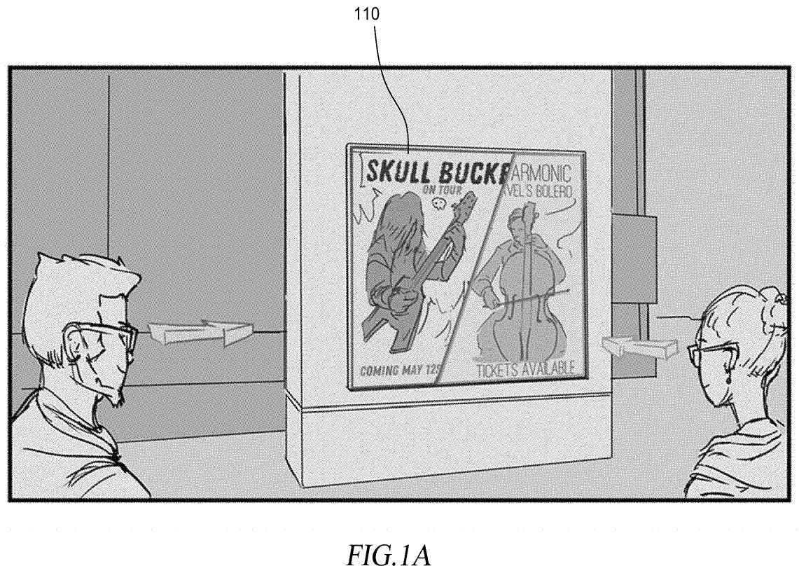

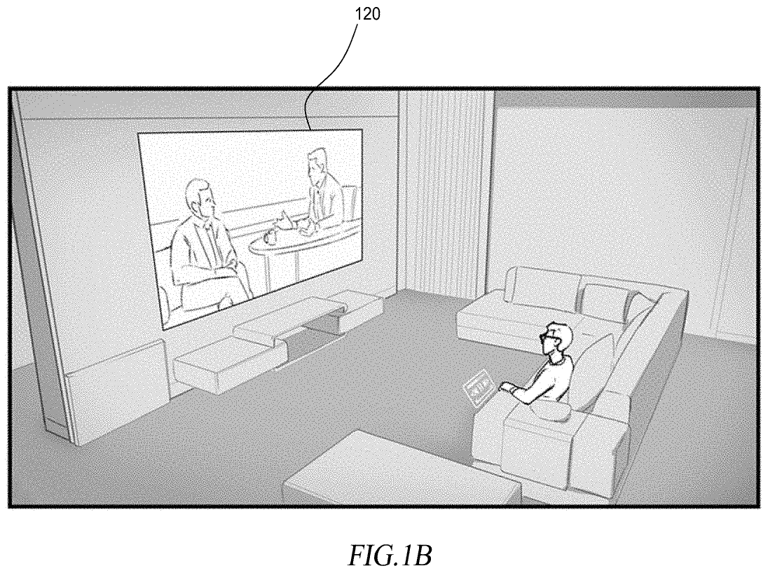

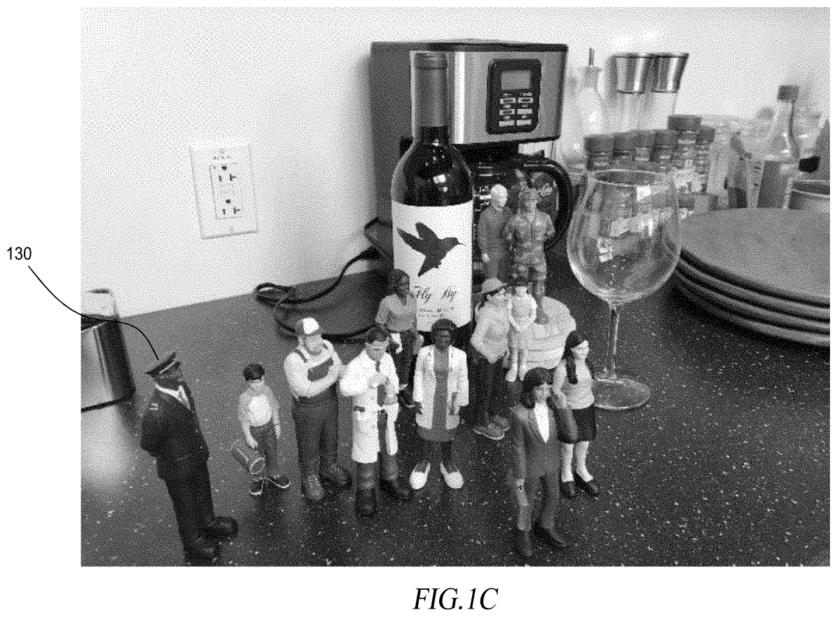

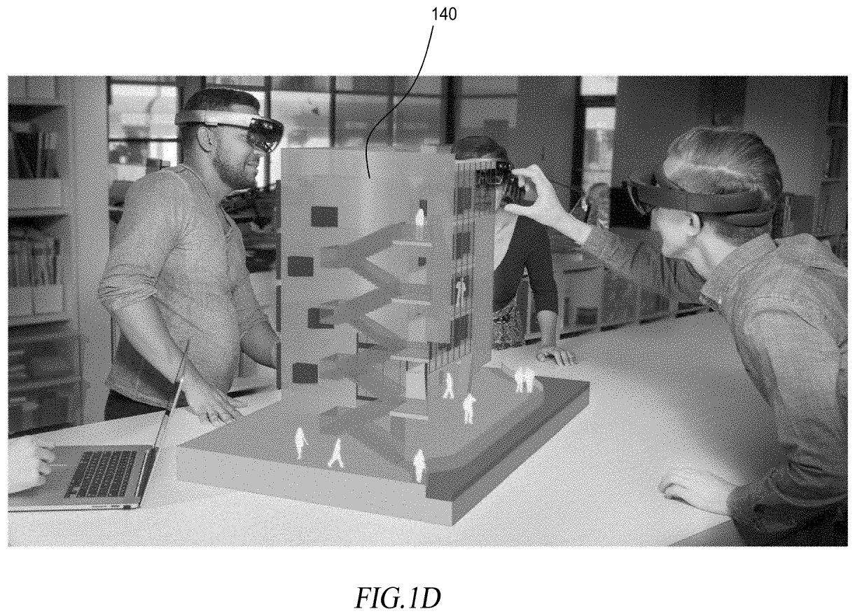

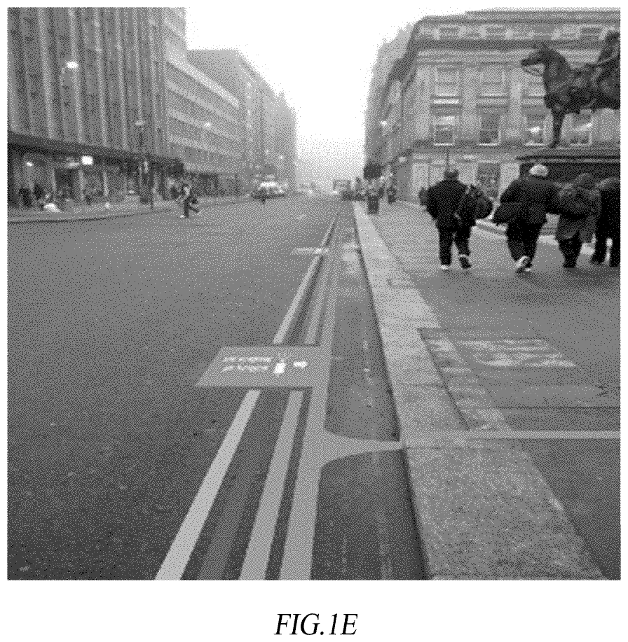

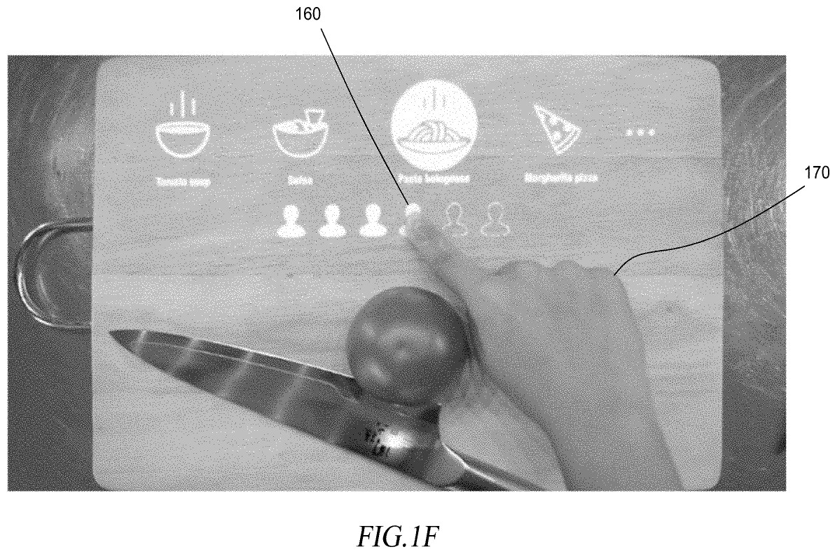

FIGS. 1A-1F illustrate examples of scenes that include objects that may be represented by surfaces. In particular embodiments, there may be three types of surfaces: image surfaces, label surfaces, and mask surfaces. Image surfaces may be used to render shaded images, for example, video frames, static images, or scenes rendered by a GPU. As an example and not by way of limitation, referencing FIG. 1A, the static image 110 (e.g., a virtual, customized billboard that changes based on the user viewing it) may be represented by an image surface. As another example and not by way of limitation, referencing FIG. 1B, each frame of a dynamic video 120 (e.g., an AR television that is “attached” to a physical object and warped appropriately) may be represented by an image surface. As another example and not by way of limitation, referencing FIG. 1C, several avatars such as the avatar 130 (e.g., a realistic avatar positioned in the scene) may be represented by an image surface. As another example and not by way of limitation, referencing FIG. 1D, the dynamic object 140 (e.g., a dynamic 3D model of a building) shown to multiple viewers concurrently to facilitate collaboration may be represented by an image surface. In particular embodiments, an image surface may store RGB (red-green-blue) components for one or more of its texels. In particular embodiments, an image surface may store RGBA (red-green-blue-alpha) components for one or more of its texels. The alpha component may be a value that specifies a level of transparency that is to be accorded to a texel. As an example and not by way of limitation, an alpha value of 0 may indicate that a texel is fully transparent, an alpha value of 1 may indicate that a texel is opaque, and alpha values in between may indicate a transparency level that is in between (the exact transparency level being determined by the value). An image surface may support any suitable image format. As an example and not by way of limitation, image surfaces may support both 16-bit and 32-bit pixel formats, with 4-bit to 10-bit RGB component sizes. In particular embodiments, each image format may have at least one bit for storing an alpha value (e.g., to allow for transparent regions).

In particular embodiments, label surfaces may store signed distances and color indexes and may be used to render objects that include solid color regions, for example, text, glyphs, and icons. As an example and not by way of limitation, referencing FIG. 1E, lines of different colors and associated text related to different bus routes for navigation purposes may be represented by one or more label surfaces, which may be fixed in space or with respect to objects. In particular embodiments, mask surfaces may store an alpha value (e.g., a value of 1) that may be used to occlude surfaces that are behind it. As an example and not by way of limitation, referencing FIG. 1F, a mask surface may occlude a portion of the surface representing the AR object 160 as the (real-world) hand 170 of a user passes in front of the AR object 160.

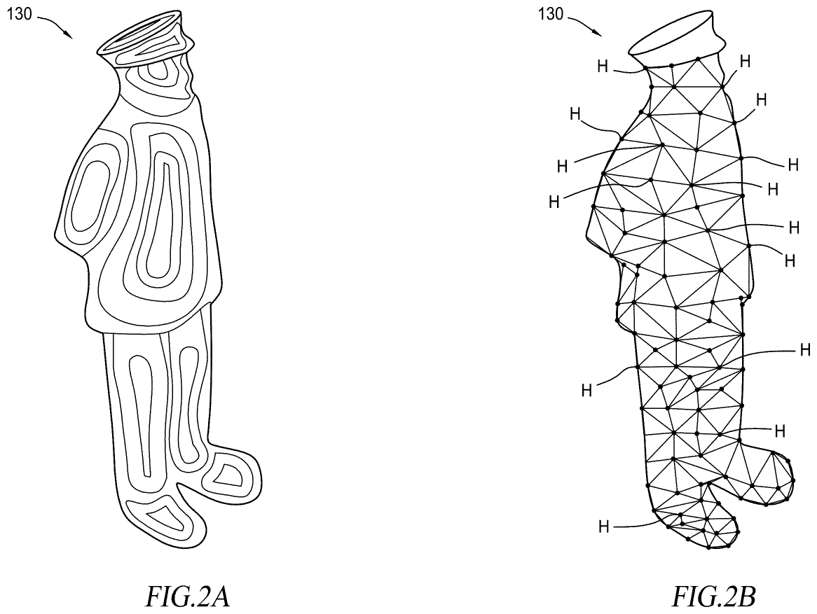

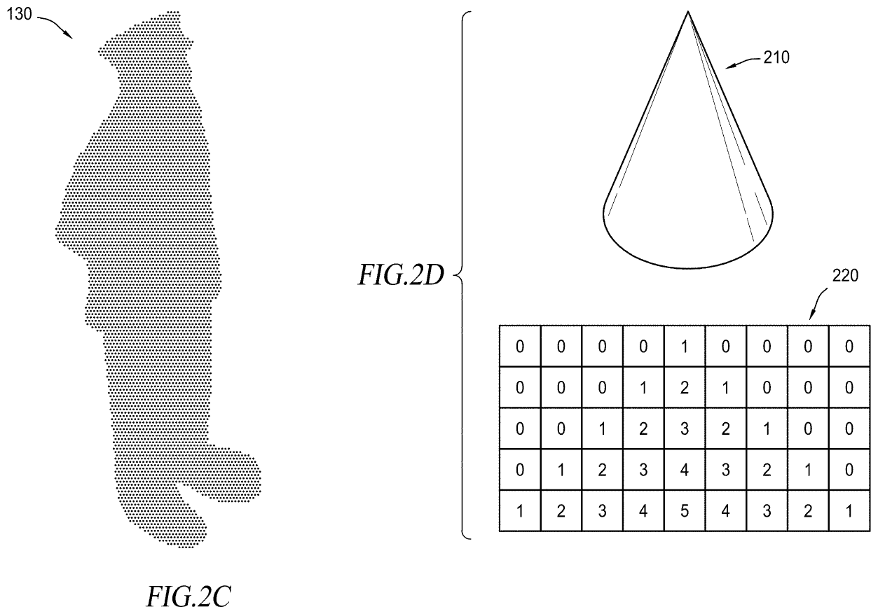

FIG. 2A illustrates a conceptual representation of a surface 130 of a 3D object (surface 130 of FIG. 1C) with an associated heightmap. Conceptually, the surface is shown as a surface with a topological map. FIG. 2B illustrates the surface 130 of FIG. 2A as a mesh representation of the heightmap. A mesh of triangles forms a portion of the surface 130 visible from a particular viewpoint. Each vertex of each triangle of the mesh is associated with a corresponding height value. FIG. 2C further illustrates a conceptual representation of the surface 130 and its associated heightmap as an array of pin-points, each point indicating a depth of a corresponding point on the surface 130.

FIG. 2D illustrates a simplified representation of how a heightmap of a surface may be stored. Simplified surface 210 is shown as a cone, and its associated heightmap is shown as a grid 220 of height values for various points on surface 210.

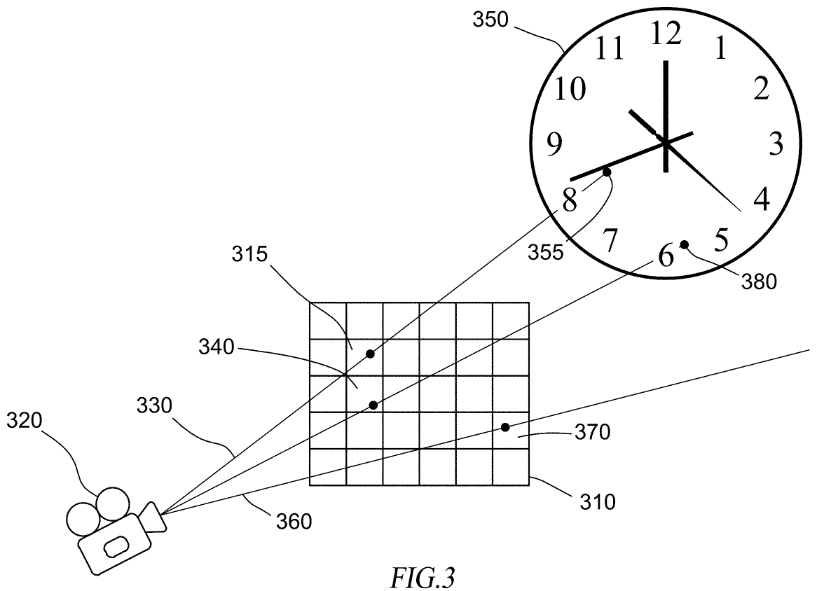

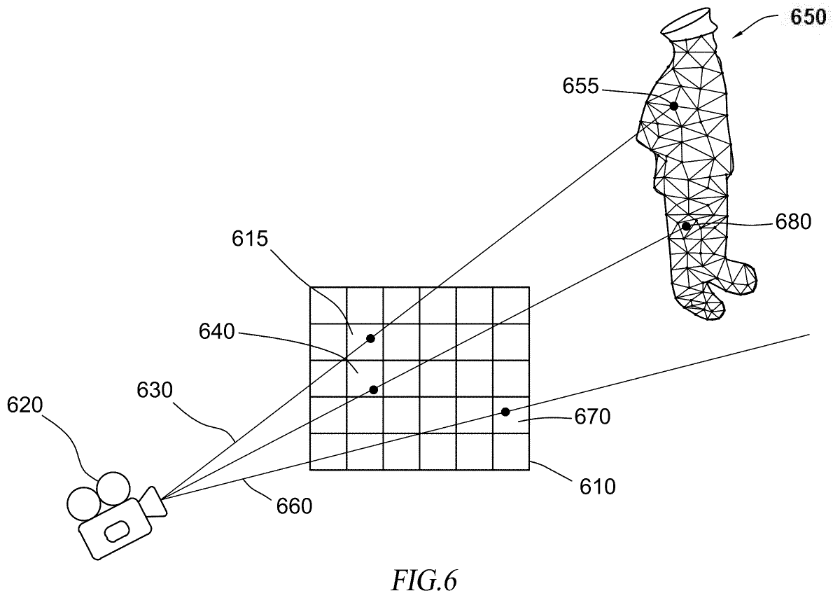

A scene may contain multiple objects, with each object being represented as either a flat quadrilateral or a heightmap. FIGS. 3-5 illustrate a process of rendering a first surface represented as a quadrilateral within a scene. FIGS. 6-8 illustrate a similar process of rendering a non-flat surface represented as a heightmap within a scene.

FIG. 3 illustrates a first “ray-casting” process for determining visual information and location information of an object that is to be displayed within a view of a scene. The object 350 in this example is a clock, and it may be among any number of objects in 3D space that could be visible from the user's viewpoint. The one or more objects in 3D space may each be represented by a 3D model (e.g., a mesh of primitives or polygons), and they could collectively be stored within a scene graph. The scene graph, in turn, may be used to render a 2D image. This rendering processes may be performed by a computing device connected to the HMD and rendered at a rate of, e.g., 30 frames per second. While ray casting is used in this example, other rendering techniques may also be used, such as ray tracing. In particular embodiments, the first computing system (e.g., a laptop, a cellphone, a desktop, a wearable device) may perform this first ray-casting process to render a view of a scene. A “view” of a scene may refer to a user perspective of the scene, which may, for example, be determined based on a current position and orientation of an HMD. To understand how an object is displayed within a view, it is helpful to imagine a number of imaginary rays emanating from a viewpoint (e.g., a “virtual camera” that may represent the viewpoint of a user viewing the scene on an HMD) to pixels on a screen (e.g., corresponding to a display on an HMD for a single eye). As an example and not by way of limitation, referencing FIG. 3, the imaginary ray 330 may emanate from the viewpoint 320 and intersect with the pixel 315 of the screen 310 (e.g., which may correspond to the display of one of two eyepieces of an HMD). As another example and not by way of limitation, the imaginary ray 360 may intersect with the pixel 370. The imaginary ray may be cast repeatedly, using what may be referred to herein as a “ray-casting process,” for all (or at least a subset) of the pixels of a screen to determine what each pixel should display (e.g., the color and transparency of the pixel). In particular embodiments, this first ray-casting process illustrated in FIG. 3 may be performed by a computing system (e.g., a wearable device, a handheld device, a laptop) that is separate from the HMD that will ultimately display a view to a user. The computing system may perform the ray-casting process and determine whether or not each of the imaginary rays intersects with an object (e.g., defined by a 3D model made up of polygons), and may further determine where on the object the imaginary ray intersects (if it does). As an example and not by way of limitation, the imaginary ray 330 may intersect with the object 350 (e.g., an AR clock) at the point of intersection 355. In this example, the computing system may determine that pixel 315 is associated with the point of intersection 355, because the ray 330 also intersects the screen 310 at the pixel 315. As another example and not by way of limitation, the imaginary ray 360 (following a course correction to account for distortion/aberration) may not intersect with the object 350. In this example, the computing system may determine that pixel 370 should not be associated with the object 350. This use of the ray-casting process may be referred to herein as a “visibility test,” because it may be used to determine the object (or portions thereof) that are visible within a given view. The ray-casting process may ultimately be used to associate pixels of the screen with points of intersection on any objects that would be visible for a view of a scene.

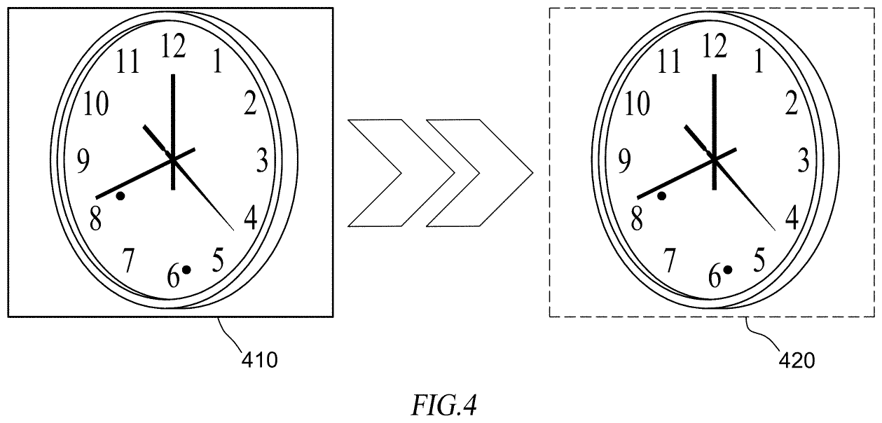

FIG. 4 illustrates a process of converting a 2D representation of an object (e.g., the object 350) to a surface. In particular embodiments, as discussed with reference to FIG. 3, the first ray-casting process may be used to generate a 2D representation of an object that is to be displayed within a view of a scene. The view may be determined, for example, based on a current position and orientation of an HMD mounted on a user's head. The 2D representation of the object may represent the object as it should appear within the view, and as such, may account for the user's perspective of the object from the view. As an example and not by way of limitation, referencing FIGS. 3 and 4, the 2D representation 410 may reflect the view of the object 350 from a perspective of a user standing to the left of the object 350 (e.g., causing the viewpoint 320 to be on the left of the object 350). In this example, to determine what the object 350 looks like from this perspective, a first ray-casting process may be performed from the viewpoint 320. The result of this first ray-casting process may produce a skewed image (e.g., as shown in the 2D representation 410) as a result of how imaginary rays from the ray-casting process would intersect the object 350 in the first ray-casting process, reflecting how the object 350 would look from the viewpoint 320. In particular embodiments, as discussed elsewhere herein, a computing system (e.g., a computing system separate from the HMD, an onboard computing system of the HMD, or any other suitable computing system) may convert the 2D representation into a surface. As an example and not by way of limitation, referencing FIG. 4, the 2D representation 410 may be converted into the surface 420, which may be an image surface that encodes visual information (RGBA) (e.g., as a texture) and location information that describes the location of the surface within a 3D space of a scene (e.g., specified in the viewer's view coordinates). A surface may be a flat surface, such as a rectangle, that is positioned within 3D space, even though it may be depicting a 3D object (e.g., analogous to a poster of a 3D object).

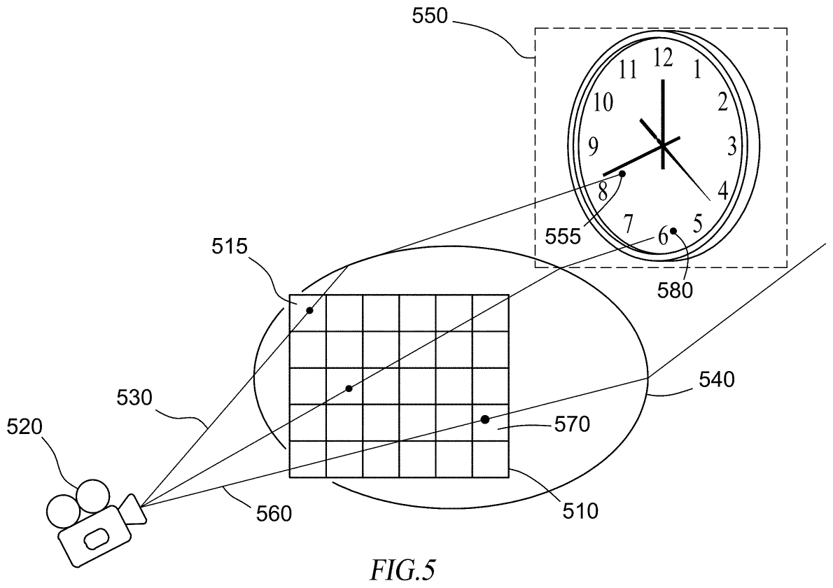

FIG. 5 illustrates an example second ray-casting process for post-warping or re-sampling a surface for display from a viewpoint of a scene. In particular embodiments, an onboard computing system of the HMD (or some other suitable second computing system) may determine how a surface should be displayed based on information associated with the surface. In particular embodiments, one or more surfaces may include location information that places them at specified locations within a 3D space associated with the scene. As an example and not by way of limitation, referencing FIG. 5, the surface 550 may be placed at its illustrated location based on associated location information. In this example, although the surface may appear to depict a 3D clock with varying depths relative to the viewer (e.g., the 9 o'clock region may appear farther away from the viewer than the 3 o'clock region), the surface, in particular embodiments, may be a flat surface that is facing the viewer (e.g., its normal vector points towards the viewer, at least initially before the viewpoint changes). Any visual representations of an object(s) may be stored as part of the surface's texture data.

In particular embodiments, each texel of a surface may have associated location information that specifies where it is to be located. In particular embodiments, similar to the first ray-casting process, a second ray-casting process may be performed by the computing system of the HMD to render a view. This second ray-casting process may be used to perform visibility tests to determine what surfaces are visible within the view, and where the surfaces are located in the view. As an example and not by way of limitation, referencing FIG. 5, the imaginary ray 530 may emanate from the viewpoint 520 and intersect with the pixel 515 of the screen 510 (e.g., the display of one of two eyepieces of an HMD). As another example and not by way of limitation, the imaginary ray 560 may intersect with the pixel 570. In particular embodiments, the computing system of the HMD may account for distortion and/or other aberrations (e.g., chromatic aberrations) introduced by the optical structures of the HMD (e.g., the lenses of an HMD). The distortions/aberrations may be corrected for mathematically. This correction may be conceptually represented as a process whereby imaginary rays travel through a distortion mesh 540 that mathematically course-corrects the imaginary rays (e.g., the imaginary ray 530, the imaginary ray 560) to account for distortions/aberrations, as shown in FIG. 5. Based on the location information of the surface 550, the computing system may determine whether or not each of the imaginary rays intersects with the surface 550 (or any other surface), and may determine where on the surface 550 the imaginary ray intersects (if it does). As an example and not by way of limitation, the imaginary ray 530 (following a course correction to account for distortion/aberration) may intersect with the surface 550 at the point of intersection 555. As another example and not by way of limitation, the imaginary ray 560 (following a course correction to account for distortion/aberration) may not intersect with the surface 550 or any other surface.

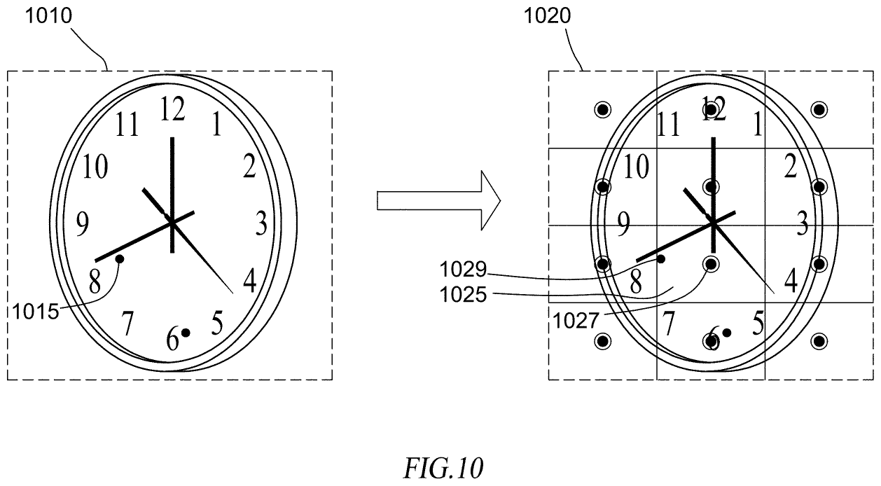

For illustrative purposes, an example use case of rendering an object will now be described using the clock example illustrated in FIGS. 3-5. The first ray casting/tracing process in FIG. 3 may render an image of a clock for a first perspective with a particular time (e.g., the time 12:42:22). This may be the time when a frame is generated by a laptop, or another suitable first computing system, such as a wearable device on the body that is separate from the HMD. From that time until the next frame is generated by the laptop (which may be generated, for illustrative purposes, at 1 frame per second), the user's perspective may change to a second perspective. To account for the change, the scene may need to be adjusted. However, the first body system may not be able to render another scene that quickly enough (e.g., at 1/200th of a second). Thus, rather than rendering the whole scene from scratch (e.g., from the 3D models of the objects), the HMD may be tasked with warping the surface (e.g., the surface 420 in FIG. 4) corresponding to the clock image generated by the laptop (still showing 12:42:22) based on the latest viewpoint information as determined by the latest position and orientation of the HMD (e.g., as may be determined based on the inertial measuring unit of the HMD), and optionally, the user's gaze (e.g., as determined by eye tracking). This is illustrated by the ray-casting and sampling process shown in FIGS. 5 and 10. The HMD may generate several subframes in this manner, each showing the same clock at 12:42:22 but from slightly different perspectives, until the next frame is generated by the laptop (e.g., with a clock that shows the time 12:42:23, if it is rendering at 1 frame per second).

As previously discussed, a surface depicting a 3D object may be flat. As such, during the warping process for generating subframes (e.g., as discussed with reference to FIG. 5), occlusions might not be properly rendered, since 3D information about the object depicted in the surface is lost. Thus, in particular embodiments, height information about the object depicted in a surface may be provided to improve the accuracy of the visibility tests. FIG. 6 illustrates the first ray-casting process for determining visual information and location information of an object represented by a 3D model that is to be displayed within a view of a scene. While ray casting is used in this example, as in the use case of FIGS. 3-5, other rendering techniques may also be used, such as ray tracing. In particular embodiments, the first computing system may perform this first ray-casting process to render a view of a scene based on a current position and orientation of an HMD. As an example, referencing FIG. 6, the imaginary ray 630 may emanate from the viewpoint 620 and intersect with the pixel 615 of the screen 610 (e.g., which may correspond to the display of one of two eyepieces of an HMD). As another example and not by way of limitation, the imaginary ray 660 may intersect with the pixel 670. The imaginary ray may again be cast repeatedly to determine what each pixel should display. The computing system performing the ray-casting process determines whether or not each of the imaginary rays intersects with the object (e.g., modeled by a mesh of triangles), and may further determine where on the object the imaginary ray intersects (if it does). As an example and not by way of limitation, the imaginary ray 630 may intersect with the object 650 at the point of intersection 655. In this example, the computing system may determine that pixel 615 is associated with the point of intersection 655, because the ray 630 also intersects the screen 610 at the pixel 615. As another example and not by way of limitation, the imaginary ray 660 may not intersect with the object 650. In this example, the computing system may determine that pixel 670 should not be associated with the object 650.

During the first rendering process, a height map for the rendered image may be generated. As illustrated in FIG. 6, the point of intersection 655 between imaginary ray 630 and object 650 is a point on the 3D model of the object 650. Since the 3D position of the object 650 is known, the rendering system could compute the distance (the depth) between the camera/viewer and that point. For example, if a ray intersects a particular triangle of the 3D model, the coordinates or depth values of the triangle's vertices may be used to compute (e.g., using interpolation) the depth of the point of intersection 655. The depth values of the points of intersections (if any) for all pixels may be stored in a depth buffer (or z buffer). As the rendering system performs visibility test against each object in 3D space, the depth buffer may be updated to track the closest object that is visible for each pixel. At the end of the visibility test, the depth buffer would include depth information for all the pixels in the image. Based on the depth buffer, the rendering engine may, for each pixel, sample a texture associated with the closest object visible through that pixel to determine the pixel's color.

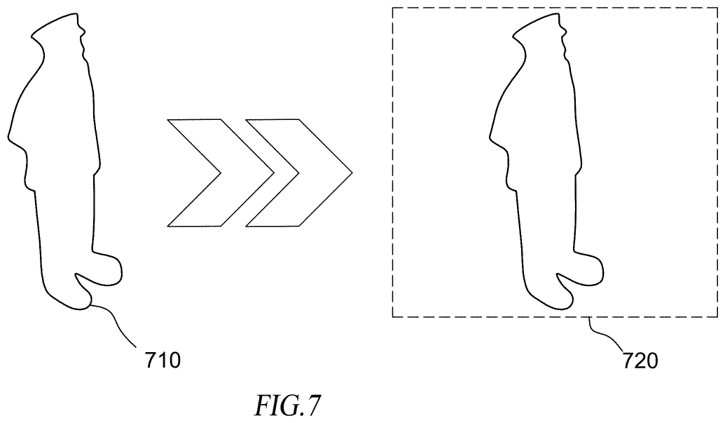

Similar to the process of FIG. 4 above, FIG. 7 illustrates a 2D representation 710 of an object (e.g., the object 650) being converted to a surface 720. The 2D representation 710 may be a rendered image that includes multiple objects (e.g., the object 650 may be a combination of several 3D models). As previously discussed with reference to FIG. 6, in particular embodiments, the first ray-casting process may be used to generate a 2D representation of an object that is to be displayed within a view of a scene. The view may be determined, for example, based on a current position and orientation of an HMD mounted on a user's head. The 2D representation of the object may represent the object as it should appear within the view, and as such, may account for the user's perspective of the object from the view. As an example and not by way of limitation, referencing FIGS. 6 and 7, the 2D representation 710 may reflect the view of the object 650 from a perspective of a user standing to the left of the object 650 (e.g., causing the viewpoint 620 to be on the left of the object 650). In this example, to determine what the object 650 looks like from this perspective, a first ray-casting process may be performed from the viewpoint 620. The result of this first ray-casting process may produce a skewed image (e.g., as shown in the 2D representation 710) as a result of how imaginary rays from the ray-casting process would intersect the object 650 in the first ray-casting process, reflecting how the object 650 would look from the viewpoint 620. In particular embodiments, as discussed elsewhere herein, a computing system (e.g., a computing system separate from the HMD, an onboard computing system of the HMD, or any other suitable computing system) may convert the 2D representation into a surface. As an example and not by way of limitation, referencing FIG. 7, the 2D representation 710 may be converted into the surface 720, which may be an image surface that encodes visual information (RGBA) (e.g., as a texture) and location information that describes the location of the surface within a 3D space of a scene (e.g., specified in the viewer's view coordinates). In addition, the surface 720 may also include height information (e.g., stored as a heightmap) specifying the 3D contour of the surface 720. In other words, the height information may be an estimate of the 3D contour of the portion of the object 650 that is visible from the viewpoint 620. As such, the height information may be generated based on the depth buffer computations made during the first rendering process, when the visibility of the object 650 was being determined (e.g., as discussed with reference to FIG. 6). In particular embodiments, the height information may include an estimated height of each pixel of the surface 720 as measured from, e.g., the pixel center. Alternatively, height information may be provided for patches of pixels (e.g., a patch may be n-by-n pixels).

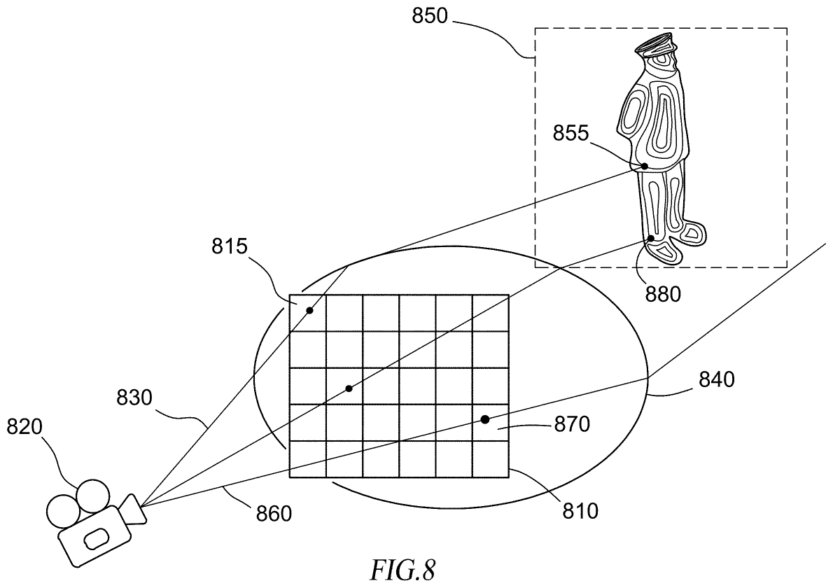

Similar to the process of FIG. 5, FIG. 8 illustrates a second ray-casting process for generating subframes from by post-warping or re-sampling a surface 850 (e.g., the surface 720 generated in FIG. 7) represented as a heightmap. In particular embodiments, the surface 850 may include location information that places it at a specified location within a 3D space associated with the scene. As an example and not by way of limitation, referencing FIG. 8, the surface 850 may be placed at its illustrated location based on associated location information. The surface 850, in particular embodiments, may be facing the viewer (e.g., the normal vector of the plane of the surface points towards the viewer, at least initially before the viewpoint changes). The height information of the surface 850 specifies the contour of the object depicted by the surface 850 (the contour is illustrated as a topological map in FIG. 8). Any color information of the depicted object may be stored as part of the surface's texture data. The texture data may include texels that correspond different portions of the surface 850. For example, if the surface 850 is represented by grids, the color of each grid may be stored within a corresponding texel.

In particular embodiments, a second ray-casting process may be performed by the computing system of the HMD to render subframes based on the main frame generated by the first ray-casting process in order to accommodate changes in viewpoints. This second ray-casting process may be used to perform visibility tests to determine what portions of surfaces are visible from the user's most-recent viewpoint. The presence of each surface 850 within the virtual 3D space is defined by the location information and height information of the surface 850. As an example and not by way of limitation, referencing FIG. 8, the imaginary ray 830 may emanate from the viewpoint 820 and intersect with the pixel 815 of the screen 810 (e.g., the display of one of two eyepieces of an HMD). As another example and not by way of limitation, the imaginary ray 860 may intersect with the pixel 870. In particular embodiments, the computing system of the HMD may account for distortion and/or other aberrations (e.g., chromatic aberrations) introduced by the optical structures of the HMD (e.g., the lenses of an HMD) and correct for them mathematically. This correction may be conceptually represented as a process whereby imaginary rays travel through a distortion mesh 840 that mathematically course-corrects the imaginary rays (e.g., the imaginary ray 830 and the imaginary ray 860) to account for distortions/aberrations, as shown in FIG. 8. Based on the location information and the height information of the surface 850, the computing system may determine whether or not each of the imaginary rays intersects with the surface 850 (or any other surface), and may determine where on the surface 850 the imaginary ray intersects (if it does). As an example and not by way of limitation, the imaginary ray 830 (following a course correction to account for distortion/aberration) may intersect with the surface 850 at the point of intersection 855. As another example and not by way of limitation, the imaginary ray 860 (following a course correction to account for distortion/aberration) may not intersect with the surface 850 or any other surface.

As illustrated in FIG. 8, surface 850 is shown conceptually as a surface with a topological map. Point of intersection 855 lies on a topological line representing a first height of a first portion of surface 850, and point of intersection 880 lies on a topological line representing a second height of a second portion of surface 850. During rendering, these portions of the surface are extruded toward the viewpoint 820 according to their different height values. However, in some embodiments, a height value may be negative. Rather than being extruded toward the viewpoint 820, a point of intersection having a negative height value would be pushed backwards from the viewpoint (e.g., to render a concave portion of a surface).

In particular embodiments, the first and/or second ray-casting processes described above with respect to FIGS. 3-5 and 6-8 may be performed separately for each eye of a user to account for slight changes in the viewpoint (e.g., based on the relative positions of the eyes). As an example and not by way of limitation, the first and second ray-casting processes may be performed for a screen associated with the left eye and for a screen associated with the right eye. These processes may run independently of each other and may even function out of sync with one another.

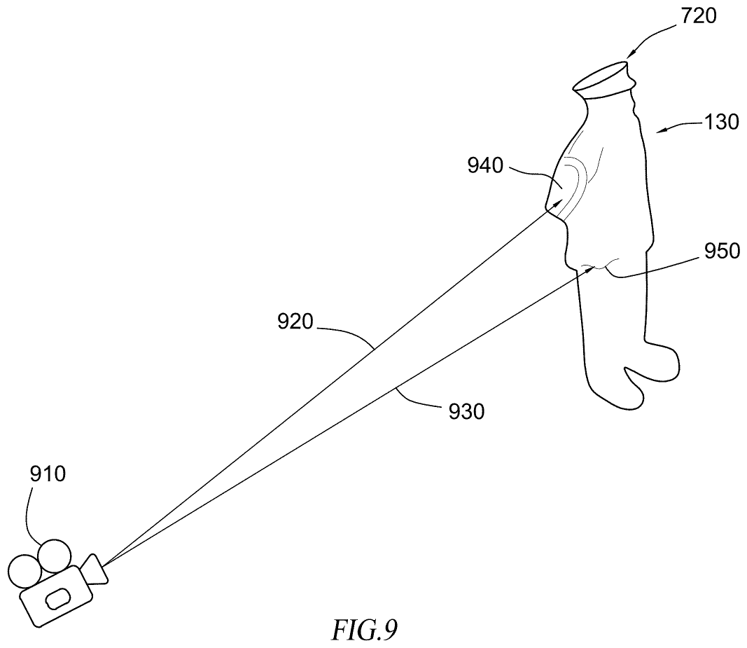

Having height values for the surfaces allow the subframes to be rendered more accurately, especially when it comes to occlusions. FIG. 9 illustrates an example of the surface 720 generated as illustrated in FIG. 7 being used to generate subframes. Rays 920 and 930 cast from the current viewpoint 910 intersect surface 720 at points 940 and 950, respectively, with these points being determined through use of the heightmap. For example, due to the 3D contour of the surface 720 defined by its heightmap, it is determined that ray 920 intersects point 940, which corresponds to the elbow of the illustrated avatar. Had the surface been flat without a heightmap, ray 920 may intersect the torso instead. However, the contours of the heightmap indicate that the elbow is protruding, so ray 920 intersects the elbow instead.

When rendering a subframe based on a surface 720, height information may be retrieved from the heightmap associated with the surface so that the contour of the surface 720 may be defined within 3D space. Visibility tests may then be performed to determine which portion of the surface should be displayed by each pixel of the display. As previously discussed, visibility tests may be performed by casting conceptional rays from the user's current viewpoint through the pixels and into the 3D space to determine where on the surface the rays would intersect. For each point of intersection, one or more corresponding texels may be retrieved from a texture associated with the surface 720. In the example shown in FIG. 9, the corresponding texture may be a profile view of the object 130 generated by a primary rendering unit (e.g., generated using the first rendering process). The texel(s) corresponding to the point of intersection may be sampled (e.g., using interpolation) to determine the color that the pixel should display.

FIG. 10 illustrates a process of identifying visual information that corresponds to points of intersection. In particular embodiments, the computing system of the HMD may display, on a screen (e.g., a screen for a single eye), a warped surface depicting an object (e.g., the clock of FIGS. 3-5) based on visual information associated with the surface. In particular embodiments, the computing system of the HMD may determine visual information (e.g., RGBA information) associated with points of intersection by determining the location of the points of intersection on a corresponding texel array. As an example and not by way of limitation, referencing FIG. 10, the surface 1010 (e.g., which may be the surface 550 in FIG. 5) may correspond to the texel array 1020, which includes texel information (e.g., RGBA information) for the surface 1010. In this example, the texel array may be entirely in 2D space, without any of the 3D location information of the surface 1010, which may be particularly beneficial in that it may greatly simplify the mathematics required to determine the visual information of a point of intersection of an imaginary ray associated with a pixel. Consequently, the computational tasks involved in the determination may require fewer resources and may be done more quickly and efficiently. As an example and not by way of limitation, the point of intersection 1015, which may be represented by a three-dimensional (x, y, z)-coordinate in the 3D view space in which the surface 1010 is placed, may be transformed into a two-dimensional (u, v)-coordinate in the texel array 1020. In this example, it may be determined that the point of intersection 1015 in the surface 1010 corresponds to the pixel sampling point 1029 in the texel array 1020. A computing system (e.g., an onboard computing system of an HMD) may determine visual information for the points of intersection based on information associated with the corresponding texel array. As an example and not by way of limitation, RGBA information for the point of intersection 1015 may be determined based on RGBA information associated with the corresponding sampling point 1029 in the texel array 1020.

In particular embodiments, the surface may only have information for a discrete number of points within each texel (e.g., the single texel center 1027 for the texel 1025). In such cases, the computing system of the HMD may perform one or more interpolations (e.g., a bilinear or a trilinear interpolation) or any other suitable calculations to determine visual information (e.g., RGBA information) associated with a particular sampling point. As an example and not by way of limitation, the computing system may perform a bilinear interpolation for the sampling point 1029 using RGBA information associated with the texel center 1027 and other neighboring texel centers (e.g., the other three texel centers surrounding the sampling point 1029) to determine RGBA information for the sampling point 1029. The HMD may display, within the corresponding pixel, a color and transparency level that may match the determined RGBA information. As an example and not by way of limitation, referencing FIGS. 5 and 10, the sampling point 1029 may correspond to the pixel 515, in which case, the RGBA information determined for the sampling point 1029 may be used to determine color and transparency level to be displayed within the pixel 515. Building on this example and not by way of limitation, rays may be cast for all the pixels of the screen 510 and display visual information for any other points where the rays intersect a surface (e.g., the point of intersection 580 intersecting the surface 550, a point of intersection of the imaginary ray 560 that may be associated with a different surface).

Though the example of FIG. 10 is illustrated as being performed on the primarily flat surface of the clock of FIGS. 3-5, a similar process of identifying visual information corresponding to points of intersection may be applied to a non-flat surface, such as that corresponding to the surfaces of FIGS. 1C and 6-8.

In particular embodiments, the computing system of the HMD may continuously or semi-continuously track the position and orientation of the HMD (e.g., using inertial, optical, depth, and/or other sensors on the HMD or on a remote device tracking the HMD) to determine the perspective of the user wearing the HMD at any given time. In particular embodiments, the computing system may also continuously or semi-continuously track the eye position of the user (e.g., to adjust for distortions resulting from lenses of the HMD that may be dependent on the user's gaze). Unfortunately, since rendering graphics is computationally expensive and takes time, new frames cannot be generated instantaneously. If there is a significant latency in updating the display to reflect a change in perspective, the user may be able to perceive the latency, creating a sensory dissonance. As further explained elsewhere herein, this sensory dissonance may contribute to unpleasant effects for the user, such as virtual reality sickness or may otherwise interrupt the user experience. To prevent this dissonance, what is displayed to the user may need to account for changes in perspective at a very rapid rate. As an example and not by way of limitation, the view of a scene may need to be modified every 1/200th of a second (e.g., because any latency beyond that may be perceptible to a user to an unacceptable degree). In many cases, it may be impractical or unfeasible for a computing system to re-render entire views (e.g., from polygons) to account for changes in perspective at such a rapid pace. As such, inventive shortcuts may be required to quickly approximate changes to the view.

In particular embodiments, one such shortcut for approximating changes to a view may involve “resampling” surfaces within a view (rather than re-rendering the entire view). In particular embodiments, resampling may involve performing a further ray-casting process to determine an approximation of how surfaces may look from an adjusted perspective. By focusing on just resampling a limited number of surfaces within a view (e.g., 16 surfaces), the view can be modified quickly—and sufficiently quickly to prevent or reduce user perception of latency. As an example and not by way of limitation, further second ray-casting processes may be performed every 1/200th of a second, to account for possible changes in perspective (e.g., from a change in position or orientation of the HMD). In particular embodiments, an onboard computing system of an HMD may resample one or more of the surfaces by performing a ray-casting process as outlined above with respect to FIG. 5, but this time with the viewpoint 520 being adjusted (e.g., moved to a different position and/or orientation) to reflect the latest perspective of the user. If the perspective has changed since the previous ray-casting process, the imaginary rays may accordingly intersect with different points of the surface. As an example and not by way of limitation, referencing FIG. 5, if the view point 520 were shifted slightly to the right (as a result of a slight head movement), the point of intersection 555 of the ray 530 may correspondingly shift to the left. Further, when shifting the view to the left, the heightmap of the surface may be used to extrude the surface in the direction of the shifted viewpoint accordingly. Modifying the view based on resampling in this manner may only be an approximation of how the view is altered by a change in perspective, and this approximation may only work for relatively small changes in perspective. But this may be all that is needed, because the purpose is to account for changes that happen in relatively short periods of time between when fully rendered frames are generated by the user's laptop or mobile phone (e.g., on the order of a hundredth of a second). Essentially, it may be a temporary fix until a view can be re-rendered (e.g., by a more powerful computing system such as a wearable device). As an example and not by way of limitation, a more powerful computing system that may be separate from the HMD (e.g., a wearable device secured to the user's belt or waistline) may re-render the view from scratch every 1/60th of a second and may send these re-rendered views to the HMD device as they are rendered. In this example, the HMD device, in the time between receiving re-rendered views every 1/60th of a second, may on its own modify surfaces (e.g., every 1/200th of a second) to account for rapid changes in user perspective.

In particular embodiments, changes in lighting conditions may be ignored in the resampling process to increase the efficiency and speed of modification. Lighting changes are at most negligible at the short time periods contemplated by the resampling process, and they may be safely ignored. This may be especially true in the context of AR, where there is already real-world lighting and where the lighting may not change much from the relatively small changes in perspective that are contemplated (e.g., changes that occur during a short time period on the order of a hundredth of a second).

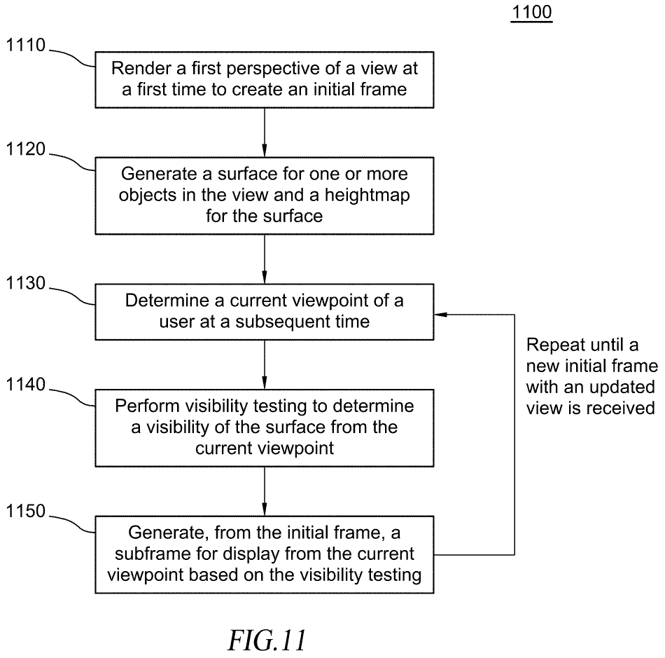

FIG. 11 illustrates an example method 1100 for generating subframes based on surfaces. The method begins at step 1110, where a first perspective of virtual objects in a scene (e.g., represented by 3D models) is rendered at a first time, to create an initial frame. This initial frame may be rendered by a first computing system (e.g., a laptop, a cellphone, a desktop, or a wearable device) at a relatively low frame rate (e.g., 60 Hz), which may be referred to as the first frame rate. The initial frame is rendered by the first computing system based on an estimated viewpoint of a user at the time of rendering.

At step 1120, the rendered information generated at the first frame rate in step 1100 may be used to generate a surface, which may include a heightmap and a texture. The surface may represent one or more virtual objects in the scene (e.g., the surface may depict a view of an avatar, which may be formed by the combination of a head object, hat object, torso object, etc.). The surface, including the associated heightmap and texture, may be generated at the first computing system (e.g., laptop, cellphone, etc.) on which the initial frame was generated, or at a separate second computing system (e.g., an onboard computing system on an HMD) that is communicatively coupled to the first computing system.

After the surface is generated, it may be accessed by, e.g., the second computing system and used to render subframes at a second frame rate (e.g., 200 Hz) higher than the first frame rate at which the initial frame was generated. For example, assuming that the initial frames and their corresponding surfaces are generated at times t₁, t₂, t₃, etc. at the rate of 60 Hz, ten subframes may be generated between times t₁ and t₂ based on the surface generated at time t₁; another ten subframes may be generated between times t₂ and t₃ based on the surface generated at time t₂; etc. Each of the subframes may be generated based on steps 1130 to 1150, as described in more detail below.

At step 1130, a current viewpoint of a user at a second time is determined. The current viewpoint of the user may be determined by using, for example, inertial measurement units, and/or any suitable tracking/localization algorithms, such as simultaneous localization and mapping (SLAM). The current viewpoint may be different from the viewpoint used for generating the initial frame in step 1110. For example, after the initial frame and corresponding surface are generated based on the user's viewpoint at time t₁, the user may continue to move or turn before another initial frame is generated at time t₂. Between time t₁ and time t₂, the computing system may determine changes in the user's viewpoint and render each subframe accordingly.

At step 1140, visibility testing is performed to determine visibility information of the surface from the viewpoint determined in step 1130. For example, visibility information of the surface with a heightmap may be obtained by casting rays against the heightmap of the surface from the current viewpoint. For example, with reference to FIG. 9, rays are cast from the current viewpoint against the heightmap of the surface, and an intersection test is performed to determine rays 920 and 930 intersect the surface at particular points of intersection 940 and 950.

At step 1150, the computing system may generate a subframe depicting the surface from the current viewpoint based on visibility information determined in step 1140 and the texture associated with the surface. As discussed in more detail elsewhere herein, the computing system may use the visibility information (e.g., point of intersection on the surface) to sample the texture of the surface to compute color information. For example, a ray that is cast from a particular pixel may intersect a particular point on the surface. The point of intersection may be mapped into texture space and used to sample the color information in that portion of the texture. The sampled color information may then be displayed by the pixel from which the ray was cast.

Any changes in perspective (e.g., slight head motions of the user that occur on the order of a hundredth of a second) may be tracked by sensors on the HMD and accounted for by the HMD by resampling the surfaces in the subframe from an adjusted viewpoint. Due to the adjustment of the viewpoint, the surfaces may be translated/moved, skewed, scaled, distorted, or otherwise changed in appearance when they are resampled. Since the scene is not being re-rendered from scratch (e.g., from polygons) and instead just by adjusting surfaces, the scene can be modified relatively quickly (e.g., at 200 Hz).

Steps 1130-1150 are repeated, using the same heightmap, each time the current viewpoint of the user changes, until a new initial frame from an updated view rendered in its entirety from primitive geometries at the lower frame rate is received.

Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for generating frames based on surfaces, including the particular steps of the method of FIG. 11, this disclosure contemplates any suitable method for generating frames based on surfaces, including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

### Display Engine Pipeline Overview

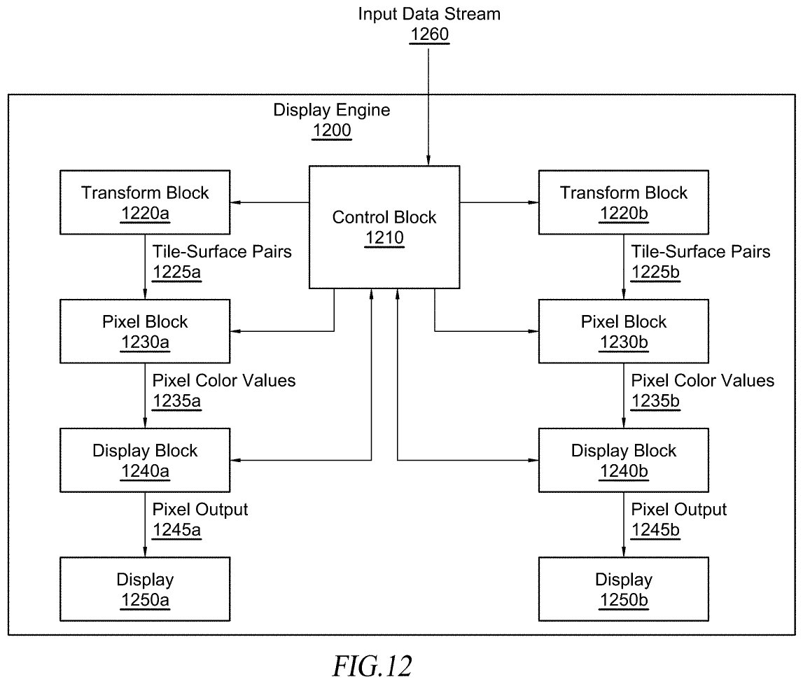

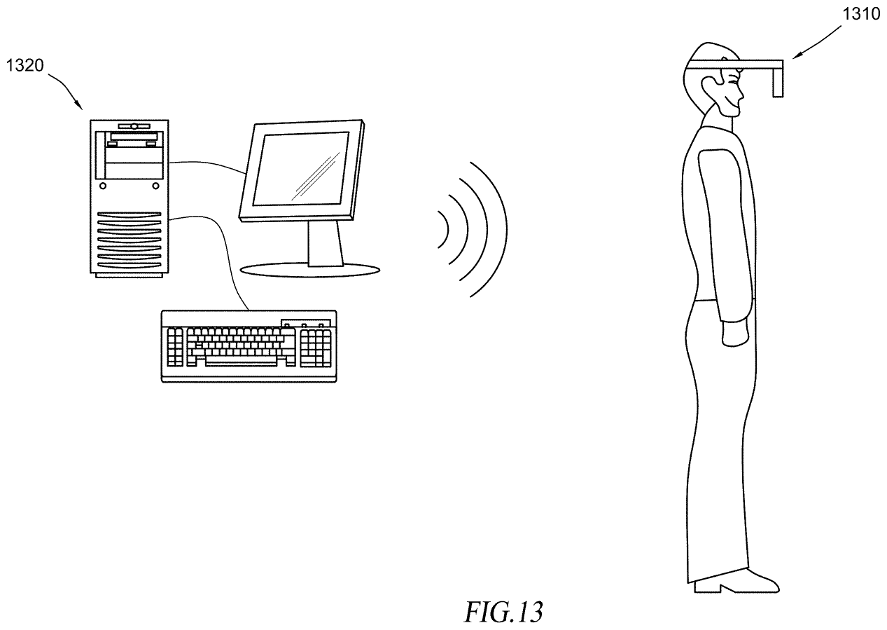

FIG. 12 illustrates a system diagram for a display engine 1200. The display engine 1200 may comprise four types of top level blocks. As shown in FIG. 12, these blocks may include a control block 1210, transform blocks 1220a and 1220b, pixel blocks 1230a and 1230b, and display blocks 1240a and 1240b. One or more of the components of the display engine 1200 may be configured to communicate via one or more high-speed bus, shared memory, or any other suitable method. As shown in FIG. 12, the control block 1210 of display engine 1200 may be configured to communicate with the transform blocks 1220a and 1220b and pixel blocks 1230a and 1230b. Display blocks 1240a and 1240b may be configured to communicate with the control block 1210. As explained in further detail herein, this communication may include data as well as control signals, interrupts and other instructions.

In particular embodiments, the control block 1210 may receive an input data stream 1260 from a primary rendering component and initialize a pipeline in the display engine 1200 to finalize the rendering for display. In particular embodiments, the input data stream 1260 may comprise data and control packets from the primary rendering component. The data and control packets may include information such as one or more surfaces comprising texture data and position data and additional rendering instructions. The control block 1210 may distribute data as needed to one or more other blocks of the display engine 1200. The control block 1210 may initiate pipeline processing for one or more frames to be displayed. In particular embodiments, an HMD may comprise multiple display engines 1200 and each may comprise its own control block 1210.

In particular embodiments, transform blocks 1220a and 1220b may determine initial visibility information for surfaces to be displayed in the artificial reality scene. In general, transform blocks (e.g., the transform blocks 1220a and 1220b) may cast rays from pixel locations on the screen and produce filter commands (e.g., filtering based on bilinear or other types of interpolation techniques) to send to pixel blocks 1230a and 1230b. Transform blocks 1220a and 1220b may perform ray casting from the current viewpoint of the user (e.g., determined using inertial measurement units, eye trackers, and/or any suitable tracking/localization algorithms, such as simultaneous localization and mapping (SLAM)) into the artificial scene where surfaces are positioned and may produce results to send to the respective pixel blocks (1230a and 1230b).

In general, transform blocks 1220a and 1220b may each comprise a four-stage pipeline, in accordance with particular embodiments. The stages of a transform block may proceed as follows. A ray caster may issue ray bundles corresponding to arrays of one or more aligned pixels, referred to as tiles (e.g., each tile may include 16×16 aligned pixels). The ray bundles may be warped, before entering the artificial reality scene, according to one or more distortion meshes. The distortion meshes may be configured to correct geometric distortion effects stemming from, at least, the displays 1250a and 1250b of the HMD. Transform blocks 1220a and 1220b may determine whether each ray bundle intersects with surfaces in the scene by comparing a bounding box of each tile to bounding boxes for each surface. If a ray bundle does not intersect with an object, it may be discarded. Tile-surface intersections are detected, and corresponding tile-surface pair 1225a and 1225b are passed to pixel blocks 1230a and 1230b.

In general, pixel blocks 1230a and 1230b determine color values from the tile-surface pairs 1225a and 1225b to produce pixel color values, in accordance with particular embodiments. The color values for each pixel are sampled from the texture data of surfaces received and stored by the control block 1210 (e.g., as part of input data stream 1260). Pixel blocks 1230a and 1230b receive tile-surface pairs 1225a and 1225b from transform blocks 1220a and 1220b, respectively, and schedule bilinear filtering. For each tile-surface pair 1225a and 1225b, pixel blocks 1230a and 1230b may sample color information for the pixels within the tile using color values corresponding to where the projected tile intersects the surface. In particular embodiments, pixel blocks 1230a and 1230b may process the red, green, and blue color components separately for each pixel. Pixel blocks 1230a and 1230b may then output pixel color values 1235a and 1235b, respectively, to display blocks 1240a and 1240b.

In general, display blocks 1240a and 1240b may receive pixel color values 1235a and 1235b from pixel blocks 1230a and 1230b, converts the format of the data to be more suitable for the scanline output of the display, apply one or more brightness corrections to the pixel color values 1235a and 1235b, and prepare the pixel color values 1235a and 1235b for output to the displays 1250a and 1250b. Display blocks 1240a and 1240b may convert tile-order pixel color values 1235a and 1235b generated by pixel blocks 1230a and 1230b into scanline- or row-order data, which may be required by the displays 1250a and 1250b. The brightness corrections may include any required brightness correction, gamma mapping, and dithering. Display blocks 1240a and 1240b may provide pixel output 1245a and 1245b, such as the corrected pixel color values, directly to displays 1250a and 1250b or may provide the pixel output 1245a and 1245b to a block external to the display engine 1200 in a variety of formats. For example, the HMD may comprise additional hardware or software to further customize backend color processing, to support a wider interface to the display, or to optimize display speed or fidelity.

### Systems and Methods

FIG. 13 illustrates an example of an HMD 1310 wirelessly connected to computer system 1320. HMD 1310 may comprise multiple display engines (e.g., the display engine of FIG. 12), and renders views of a scene at a relatively high frame rate through the processes of FIGS. 3-5 and 6-8. Computer system 1320, by contrast, may comprise a more powerful GPU, and render entire frames at a relatively low frame rate when compared to HMD 1310. Computer 1320 may transmit each entire rendered frame to HMD 1310. Though HMD 1310 is illustrated as being connected to computer system 1320 wirelessly, this disclosure contemplates any suitable type of connection, including wired connections. Similarly, though FIG. 13 illustrates a single HMD connected to a single computer system, this disclosure contemplates multiple HMDs connected to one or more computer systems.

Although this disclosure focuses on AR objects in an AR environment, it contemplates rendering VR objects in a VR environment too. As an example and not by way of limitation, in the case of VR, computing system 1320 (e.g., a wearable device, a handheld device, or a laptop) may render an entire VR initial scene for display to a user. Surfaces may be generated by computing system 1320 for VR objects within the scene. The initial scene and the surfaces may be sent to VR HMD 1310, which may include a separate computing system that is able to modify the surfaces in response to detected changes in perspective (e.g., detected based on position and orientation of the HMD as further explained elsewhere herein). In an alternative embodiment, VR HMD 1310 may simply receive the initial scene and may on its own generate surfaces for the scene that it then modifies.

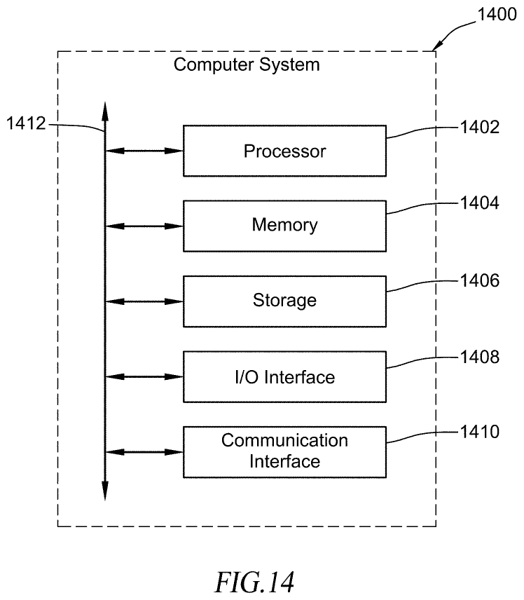

FIG. 14 illustrates an example computer system 1400. In particular embodiments, one or more computer systems 1400 perform one or more steps of one or more methods described or illustrated herein. In particular embodiments, one or more computer systems 1400 provide functionality described or illustrated herein. In particular embodiments, software running on one or more computer systems 1400 performs one or more steps of one or more methods described or illustrated herein or provides functionality described or illustrated herein. Particular embodiments include one or more portions of one or more computer systems 1400. Herein, reference to a computer system may encompass a computing device, and vice versa, where appropriate. Moreover, reference to a computer system may encompass one or more computer systems, where appropriate.

This disclosure contemplates any suitable number of computer systems 1400. This disclosure contemplates computer system 1400 taking any suitable physical form. As example and not by way of limitation, computer system 1400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1400 may include one or more computer systems 1400; be unitary or distributed; span multiple locations; span multiple machines; span multiple data centers; or reside in a cloud, which may include one or more cloud components in one or more networks. Where appropriate, one or more computer systems 1400 may perform without substantial spatial or temporal limitation one or more steps of one or more methods described or illustrated herein. As an example and not by way of limitation, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

In particular embodiments, computer system 1400 includes a processor 1402, memory 1404, storage 1406, an input/output (I/O) interface 1408, a communication interface 1410, and a bus 1412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1402 includes hardware for executing instructions, such as those making up a computer program. As an example and not by way of limitation, to execute instructions, processor 1402 may retrieve (or fetch) the instructions from an internal register, an internal cache, memory 1404, or storage 1406; decode and execute them; and then write one or more results to an internal register, an internal cache, memory 1404, or storage 1406. In particular embodiments, processor 1402 may include one or more internal caches for data, instructions, or addresses. This disclosure contemplates processor 1402 including any suitable number of any suitable internal caches, where appropriate. As an example and not by way of limitation, processor 1402 may include one or more instruction caches, one or more data caches, and one or more translation lookaside buffers (TLBs). Instructions in the instruction caches may be copies of instructions in memory 1404 or storage 1406, and the instruction caches may speed up retrieval of those instructions by processor 1402. Data in the data caches may be copies of data in memory 1404 or storage 1406 for instructions executing at processor 1402 to operate on; the results of previous instructions executed at processor 1402 for access by subsequent instructions executing at processor 1402 or for writing to memory 1404 or storage 1406; or other suitable data. The data caches may speed up read or write operations by processor 1402. The TLBs may speed up virtual-address translation for processor 1402. In particular embodiments, processor 1402 may include one or more internal registers for data, instructions, or addresses. This disclosure contemplates processor 1402 including any suitable number of any suitable internal registers, where appropriate. Where appropriate, processor 1402 may include one or more arithmetic logic units (ALUs); be a multi-core processor; or include one or more processors 1402. Although this disclosure describes and illustrates a particular processor, this disclosure contemplates any suitable processor.

In particular embodiments, memory 1404 includes main memory for storing instructions for processor 1402 to execute or data for processor 1402 to operate on. As an example and not by way of limitation, computer system 1400 may load instructions from storage 1406 or another source (such as, for example, another computer system 1400) to memory 1404. Processor 1402 may then load the instructions from memory 1404 to an internal register or internal cache. To execute the instructions, processor 1402 may retrieve the instructions from the internal register or internal cache and decode them. During or after execution of the instructions, processor 1402 may write one or more results (which may be intermediate or final results) to the internal register or internal cache. Processor 1402 may then write one or more of those results to memory 1404. In particular embodiments, processor 1402 executes only instructions in one or more internal registers or internal caches or in memory 1404 (as opposed to storage 1406 or elsewhere) and operates only on data in one or more internal registers or internal caches or in memory 1404 (as opposed to storage 1406 or elsewhere). One or more memory buses (which may each include an address bus and a data bus) may couple processor 1402 to memory 1404. Bus 1412 may include one or more memory buses, as described below. In particular embodiments, one or more memory management units (MMUs) reside between processor 1402 and memory 1404 and facilitate accesses to memory 1404 requested by processor 1402. In particular embodiments, memory 1404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1404 may include one or more memories 1404, where appropriate. Although this disclosure describes and illustrates particular memory, this disclosure contemplates any suitable memory.

In particular embodiments, storage 1406 includes mass storage for data or instructions. As an example and not by way of limitation, storage 1406 may include a hard disk drive (HDD), a floppy disk drive, flash memory, an optical disc, a magneto-optical disc, magnetic tape, or a Universal Serial Bus (USB) drive or a combination of two or more of these. Storage 1406 may include removable or non-removable (or fixed) media, where appropriate. Storage 1406 may be internal or external to computer system 1400, where appropriate. In particular embodiments, storage 1406 is non-volatile, solid-state memory. In particular embodiments, storage 1406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1406 taking any suitable physical form. Storage 1406 may include one or more storage control units facilitating communication between processor 1402 and storage 1406, where appropriate. Where appropriate, storage 1406 may include one or more storages 1406. Although this disclosure describes and illustrates particular storage, this disclosure contemplates any suitable storage.

In particular embodiments, I/O interface 1408 includes hardware, software, or both, providing one or more interfaces for communication between computer system 1400 and one or more I/O devices. Computer system 1400 may include one or more of these I/O devices, where appropriate. One or more of these I/O devices may enable communication between a person and computer system 1400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1408 for them. Where appropriate, I/O interface 1408 may include one or more device or software drivers enabling processor 1402 to drive one or more of these I/O devices. I/O interface 1408 may include one or more I/O interfaces 1408, where appropriate. Although this disclosure describes and illustrates a particular I/O interface, this disclosure contemplates any suitable I/O interface.

In particular embodiments, communication interface 1410 includes hardware, software, or both providing one or more interfaces for communication (such as, for example, packet-based communication) between computer system 1400 and one or more other computer systems 1400 or one or more networks. As an example and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1410 for it. As an example and not by way of limitation, computer system 1400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1400 may include any suitable communication interface 1410 for any of these networks, where appropriate. Communication interface 1410 may include one or more communication interfaces 1410, where appropriate. Although this disclosure describes and illustrates a particular communication interface, this disclosure contemplates any suitable communication interface.

In particular embodiments, bus 1412 includes hardware, software, or both coupling components of computer system 1400 to each other. As an example and not by way of limitation, bus 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1412 may include one or more buses 1412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The claims:

1. A method comprising:
receiving, by a head-mounted device connected to a computing system, a surface that represents visible portions of one or more 3D virtual objects in a scene as viewed from a first viewpoint in a 3D space of the scene, wherein:
the first viewpoint is determined based on a first pose of the head-mounted device at a first time,
the surface is associated with a heightmap, location information of the surface in the 3D space of the scene, and a texture,
the surface, heightmap, and texture are generated based on rendered information generated by the computing system at a first frame rate, and
the heightmap indicates heights of points on a contour of the surface;
sequentially rendering, by the head-mounted device and before receiving a second frame from the computing system, a plurality of subframes at a second frame rate that is higher than the first frame rate, wherein each of the plurality of subframes is generated by:
determining a current viewpoint of a user within the 3D space of the scene based on a current pose of the head-mounted device at a different time than the first time associated with the first frame,
determining visibility information of the surface by casting rays from the current viewpoint against the contour of the surface defined by the heights of points indicated by the heightmap;
generating the subframe depicting the surface from the current viewpoint based on the visibility information of the surface and the texture; and
sequentially displaying the plurality of subframes.

2. The method of claim 1, wherein the heightmap comprises a mesh of polygons that defines a contour of the surface.

3. The method of claim 2, wherein a topology of the mesh is fixed.

4. The method of claim 2, wherein each vertex of the mesh comprises respective height information.

5. The method of claim 1, further comprising, subsequent to the displaying of the plurality of subframes, accessing a second surface rendered at the first frame rate, wherein the second surface comprises a second heightmap and is associated with a second texture.

6. The method of claim 1, further comprising, subsequent to the displaying of the plurality of subframes, accessing an updated surface rendered at the first frame rate, the updated surface comprising the surface from an updated viewpoint.

7. The method of claim 6, wherein the rendering of the plurality of subframes comprises rendering the plurality of subframes between a first time of the accessing of the surface and a second time of the accessing of the updated surface.

8. The method of claim 1, wherein the one or more virtual objects correspond to virtual representations of one or more physical objects, wherein the heightmap of the surface is generated based on distance measurements of the one or more physical objects.

9. The method of claim 8, wherein the distance measurements of the one or more physical objects are from different viewpoints.

10. The method of claim 1, wherein the determining of the current viewpoint of the user comprises detecting a position and orientation of the computing system and of the eyes of the user.

11. The method of claim 1, wherein the rendered information comprises z-buffer data for rendering the texture, wherein the heightmap is generated based on the z-buffer data.

12. The method of claim 1, wherein the one or more virtual objects represented by the surface are virtual objects that are predicted to change in appearance as a single unit during a change of the current viewpoint of the user.

13. The method of claim 1, wherein the rendering of the plurality of subframes comprises, for each of the plurality of subframes, re-rendering the rendered information at the second frame rate based on the rendered information and the current viewpoint.

14. The method of claim 1, wherein the heightmap comprises topology information of the surface.

15. The method of claim 1, wherein the heightmap is generated based on a depth buffer comprising depth information of the surface rendered from a plurality of viewpoints.

16. The method of claim 1, wherein the heightmap is generated from an initial viewpoint based on a depth map comprising depth information of the surface from a plurality of viewpoints.

17. The method of claim 16, wherein the initial viewpoint is selected from among a plurality of viewpoints associated with the depth map.

18. A system comprising one or more processors and a memory coupled to the processors, the memory comprising instructions that, when executed by the processors, configure the processors to:
receive, by a head-mounted device connected to a computing system, a surface that represents visible portions of one or more 3D virtual objects in a scene as viewed from a first viewpoint in a 3D space of the scene, wherein:
the first viewpoint is determined based on a first pose of the head-mounted device at a first time,
the surface is associated with a heightmap, location information of the surface in the 3D space of the scene, and a texture,
the surface, heightmap, and texture are generated based on rendered information generated by the computing system at a first frame rate, and
the heightmap indicates heights of points on a contour of the surface;
sequentially render, by the head-mounted device and before receiving a second frame from the computing system, a plurality of subframes at a second frame rate that is higher than the first frame rate, wherein each of the plurality of subframes is generated by:
determine a current viewpoint of a user within the 3D space of the scene based on a current pose of the head-mounted device at a different time than the first time associated with the first frame,
determine visibility information of the surface by casting rays from the current viewpoint against the contour of the surface defined by the heights of points indicated by the heightmap;
generate the subframe depicting the surface from the current viewpoint based on the visibility information of the surface and the texture; and
sequentially display the plurality of subframes.

19. The system of claim 18, wherein the processors are further configured to, subsequent to the displaying of the plurality of subframes, access an updated surface rendered at the first frame rate, the updated surface comprising the surface from an updated viewpoint, wherein the rendering of the plurality of subframes comprises rendering the plurality of subframes between a first time of the accessing of the surface and a second time of the accessing of the updated surface.

20. One or more computer-readable non-transitory storage media embodying software that is configured, when executed by a processor, to:
receive, by a head-mounted device connected to a computing system, a surface that represents visible portions of one or more 3D virtual objects in a scene as viewed from a first viewpoint in a 3D space of the scene, wherein:
the first viewpoint is determined based on a first pose of the head-mounted device at a first time,
the surface is associated with a heightmap, location information of the surface in the 3D space of the scene, and a texture,
the surface, heightmap, and texture are generated based on rendered information generated by the computing system at a first frame rate, and
the heightmap indicates heights of points on a contour of the surface;
sequentially render, by the head-mounted device and before receiving a second frame from the computing system, a plurality of subframes at a second frame rate that is higher than the first frame rate, wherein each of the plurality of subframes is generated by:
determine a current viewpoint of a user within the 3D space of the scene based on a current pose of the head-mounted device at a different time than the first time associated with the first frame,
determine visibility information of the surface by casting rays from the current viewpoint against the contour of the surface defined by the heights of points indicated by the heightmap;
generate the subframe depicting the surface from the current viewpoint based on the visibility information of the surface and the texture; and
sequentially display the plurality of subframes.
